(19) United States
(12) Patent Application Publication
(10) Pub. No.: US 2009/0228549 A1
(43) Pub. Date: Sep. 10, 2009

(54) METHOD OF TRACKING USAGE OF CLIENT COMPUTER AND SYSTEM FOR SAME

(75) Inventor: Daniel Chick, Amersham (GB)

Correspondence Address: BRYAN CAVE LLP, TWO NORTH CENTRAL AVENUE, SUITE 2200, PHOENIX, AZ, 85004, US

(73) Assignee: Internet Business Group Limited, London (GB)

(21) Appl. No.: 12/398,838

(22) Filed: Mar. 5, 2009

(30) Foreign Application Priority Data
Mar. 7, 2008 (GB) 0804346.5

(51) Int. Cl. G06F 15/16; G06Q 30/00; G06F 17/30

(52) U.S. Cl. 709/203; 709/224; 705/14; 707/100; 707/E17.044; 707/10

(57) ABSTRACT

Some embodiments disclose a method of tracking usage of a client computer. The method can include: (a) receiving a first request for a first file from the client computer; (b) assigning first identifying information to the client computer, the first identifying information is associated with the client computer; (c) providing the first file with a first header to the client computer, the first header comprises the first identifying information; (d) receiving a first conditional request for the first file from the client computer, the first conditional request comprises second identifying information; (e) accessing first data about the client computer using the second identifying information after receiving the first conditional request if the first identifying information is the same as the second identifying information; and (f) instructing the client computer to display at least one second file after receiving the first conditional request if the first identifying information is the same as the second identifying information. Other embodiments are disclosed in this application.

### CROSS-REFERENCE TO RELATED APPLICATIONS

This application claims the benefit of British Patent Application No. GB0804346.5, filed Mar. 7, 2008, which is incorporated herein by reference.

### FIELD OF THE INVENTION

This invention relates generally to methods of tracking a client computer, and relates more particularly to methods to track a client computer by storing identifying information in the client computer and a systems and apparatuses for the same.

### DESCRIPTION OF THE BACKGROUND

Many companies and web sites track the behavior and usage patterns of individual users on the Internet, for instance, for the purposes of delivering relevant content or third party advertising. For example, a user can view a web site using an internet browser running on a client computer and specify they want access to specific content areas of the web site. On returning to that web site, the web site can “remember” their settings and presents the user with the content that they previously specified. Alternatively, an advertising network can deliver advertisements to users across a number of separate web pages or web sites by tracking the usage patterns of the individual users on these web sites. Advertisers may track the users so they can deliver relevant advertising to that individual user across all the web pages or web sites that are part of their network.

Normally, the individual user's behavior and usage patterns are tracked using a small file called a cookie. When a user accesses a server, the server is able to deliver a cookie to the user's computer (i.e., the client computer). The cookie can contain a unique identifier for that individual user. The cookie is stored on the client computer in its own file, separate from any other files transferred from the server.

To locally store a cookie and other files locally on a client computer, a typical feature of software (e.g., an Internet browser) used on client computers to access servers is use of a “browser cache.” In some examples, the browser cache is a portion of the storage component (i.e., memory) of the client computer that is used to store information previously downloaded from the Internet. Implementation of a browser cache can improve the response time for accessing a web page by ensuring that the Internet browser does not need to repeatedly download a file that it has downloaded previously. The browser cache, when used with cookies, ensures that the file is only downloaded on the first access, and subsequent accesses do not require the file to be downloaded again, as the locally stored copy is displayed from the browser cache.

The server also creates an entry with the unique identifier in a database, and stores any behavior or usage information for that user in the database. Subsequently, when the user accesses the server from the same client computer (either immediately or days, months or even years later), the server is able to access the contents of the cookie (i.e., the unique identifier) and retrieve information from the database related to that unique identifier, in order to process and deliver information and content for that user as appropriate. For example, the database or cookie might hold the name or username of the user so when returning to the web site, the user is greeted with their own name, and might even be logged into the web site without having to enter their username.

However, in recent years, the cookie has obtained bad publicity due to its perceived intrusion into the user's privacy. Many users now disable or restrict the use of cookies on their computers. This disabling of cookies causes the functionality and enhancements of web sites to be impeded. Furthermore, cookies are also vulnerable to deletion and corruption by virtue of their accessibility by users.

Accordingly, a need or potential for benefit exists for an alternative to the use of cookies for deploying and retrieving identifying information to and from a client computer.

### BRIEF DESCRIPTION OF THE DRAWINGS

To facilitate further description of the embodiments, the following drawings are provided in which:

FIG. 1 is a block diagram of an example of an apparatus or system configured to track usage of at least one client computer, according to a first embodiment;

FIG. 2 is a flow chart illustrating a method of displaying information from a server using a client computer, according to the first embodiment;

FIG. 3 is a flow chart illustrating an example of activity of processing the request for the file, according to the first embodiment;

FIG. 4 is a flow chart illustrating an example of activity of processing the request for the first file, according to the first embodiment;

FIG. 5 is a flow chart illustrating an example of activity of processing the conditional request for the first file, according to the first embodiment;

FIG. 6 is a flow chart illustrating a method of displaying information from a server using a client computer, according to a second embodiment;

FIG. 7 is a flow chart illustrating an example of activity of processing the request for the first file, according to the second embodiment;

FIG. 8 is a flow chart illustrating an example of activity of processing the request for the first file, according to the second embodiment;

FIG. 9 is a flow chart illustrating an example of activity of processing the second file, according to the second embodiment;

FIG. 10 is a flow chart illustrating an example of activity of processing the third file and the first instructions, according to the second embodiment;

FIG. 11 is a flow chart illustrating an example of process of processing the conditional request for the second file, according to the second embodiment;

FIG. 12 is a front view illustrating a computer that is suitable for implementing an embodiment of a server or a client computer, according to an embodiment; and

FIG. 13 is a representative block diagram of the elements included on the circuit boards inside a chassis of the computer of FIG. 12.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically and/or otherwise, through intervening circuitry and/or elements. Two or more electrical elements may be electrically coupled but not be mechanically coupled; two or more mechanical elements may be mechanically coupled, but not be electrically coupled; two or more electrical elements may be mechanically coupled, but not be electrically coupled. Coupling (whether only mechanical, only electrical, or both) may be for any length of time, e.g., permanent or semi-permanent or only for an instant.

“Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types.

### DETAILED DESCRIPTION OF EXAMPLES OF EMBODIMENTS

Some embodiments include a method of tracking usage of a client computer. The method can include, for example: (a) receiving from the client computer a first request for a first file; (b) assigning first identifying information to the client computer, the first identifying information is associated with the client computer; (c) providing the first file with a first header to the client computer, the first header comprises the first identifying information; (d) receiving from the client computer a first conditional request for the first file, the first conditional request comprises second identifying information; (e) accessing first data about the client computer using the second identifying information after receiving the first conditional request if the first identifying information is the same as the second identifying information; and (f) instructing the client computer to display at least one second file after receiving the first conditional request if the first identifying information is the same as the second identifying information.

Various embodiments include a method of displaying at least one first file from a server using a client computer. The method can include, for example: (a) sending a first request for a second file to the server, (b) receiving the second file with a first header, the first header comprises identifying information, the identifying information is associated with the client computer; (c) storing the second file with the identifying information; (d) sending a first conditional request for the second file to the server, the first conditional request comprises the first identifying information; (e) receiving first instructions from the server to display the at least one first file; and (f) displaying the at least one first file to the user using the client computer.

Many embodiments include a computer-readable storage medium that stores instructions executable by at least one processor on a server. The computer-readable storage medium can include, for example: (a) instructions for processing a first request for a first file from a client computer; (b) instructions for assigning and facilitate storing first identifying information to the client computer; (c) instructions for providing the first file with a first header to the client computer, the first header comprises the first identifying information; (d) instructions for receiving and processing a first conditional request for the first file from the client computer, the first conditional request comprises second identifying information; (e) instructions for accessing first data about the client computer after receiving the first conditional request; and (f) instructions for instructing the client computer to display at least one second file after receiving the first conditional request if the first identifying information is the same as the second identifying information.

The same or different embodiments include a computer-readable storage medium that stores instructions executable by at least one processor on a client computer. The computer-readable storage medium can include, for example: (a) instructions for sending a first request for a first file to a server; (b) instructions for receiving and processing the first file with a first header, the first header comprises first identifying information, the first identifying information is associated with the client computer; (c) instructions for facilitating storing of the first file with the first header; (d) instructions for sending a first conditional request for the first file to the server, the first conditional request comprises the first identifying information; (e) instructions for receiving and processing first instructions from the server; and (f) instructions for displaying at least one second file to the user based on the first instructions.

Communication between a client computer and server on the Internet is typically performed using a defined set of rules and guidelines specified by the W3C foundation called the HTTP (Hyper Text Transfer Protocol) Specification. These rules and guidelines are exhaustive and form the basis for how the software used to access the Internet on a client computer (e.g., an Internet browser) operates and how the client computer communicates with a server. While the HTTP Specification is interpreted slightly differently, in some cases, between different software, the HTTP Specification is typically followed fairly closely. This standardization allows client computers and servers to communicate with each other effectively even though there are many different manufacturers and developers of both client and server software used for communicating over the Internet.

The method by which many of these rules and guidelines are implemented in software is through the use of “HTTP headers.” When a client computer sends a request to access a server, a request is sent in a format specified by the HTTP Specification in the form of a number of “headers.” These headers include, for example, the location of the file on the server requested by the client computer, the date/time that the request was sent to the server, the format of the expected reply and other pieces of information. When the server returns data to the client computer, the actual content of the reply (for example, an HTML web page or a graphics file) is preceded by a number of HTTP headers. These headers contain information such as the length of the reply, the format (MIME type) of the data being returned, the date/time that the response was last modified, etc.

One common set of HTTP header, the “Etag” (Entity Tag) and “if-none-match” HTTP headers are used in controlling the caching of files in an Internet browser. Web sites can include one or more web pages. A typical web page is made up of a number of different files, which could include HTML files, multiple image files, video files, audio files, executable files, text files, and the like. Often many pages within a given web site could contain the same file (i.e., shared content). For example, a corporate logo can appear on every web page in a given web site. Since one client computer may access multiple pages on the same web site, the client computer will access the same corporate logo file multiple times.

When delivering a file to a client computer over a network using the HTTP Specification, a server can include the HTTP header called “Etag” with the file. Typically, the value assigned to the Etag header is based on the file size and last modified date of the file stored on the server. Under the HTTP Specification, the value of the Etag header is the same every time that file is requested by a client computer, unless the file is changed in some way. The Internet browser on the client computer stores the value of this Etag header along with the file and the URL (Universal Resource Locator) of the file on the server.

When the client computer makes a request to a server, the client computer initially checks if there is a local version of the file at the URL that is being requested stored in its browser cache. If there is a locally stored copy of the file, the request sent from the client computer to the server includes an HTTP header named “if-none-match,” with a value matching the value of the Etag HTTP header when the file was originally requested. The server, on receiving the request containing this HTTP header, checks if the file stored has an Etag matching the value of this “if-none-match” HTTP header. If it does match, the server responds with a status of “304 not-modified,” which tells the client computer to use the locally cached version of the file. If the Etag value does not match, the server responds as normal with the entire contents of the file.

Without using a cookie, embodiments of the invention can use and manipulate the properties of this Etag header in order to track a client computer making subsequent requests to a server. By manipulating the value of the Etag header for a given file and exploiting the process outlined above, it is possible to track a client computer using identifying information, which is stored in the client computer's browser cache as an Etag value for a specific file.

As used herein, “Etag header” refers to the Etag header field specified in the W3C Foundation's HTTP Specification.

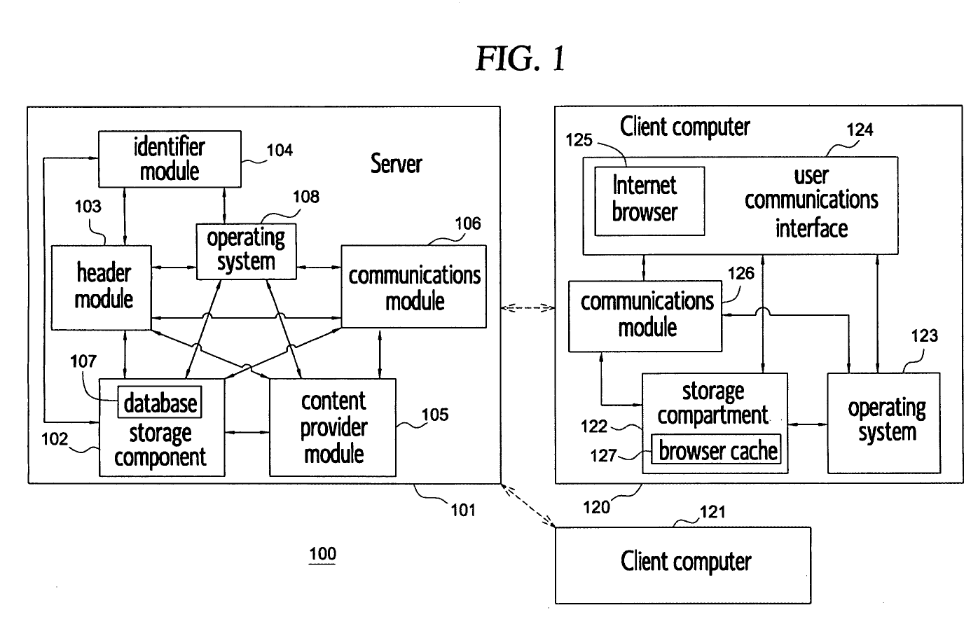

Turning to the drawings, FIG. 1 is a block diagram of an example of an apparatus or system 100 configured to track usage of a client computer 120 and/or 121, according to a first embodiment. In some examples, system 100 or a portion thereof can be considered a system 100 configured to display information from a server 101 using a client computer 120 and/or 121. System 100 is merely exemplary, different embodiments of the invention are not limited to the specific embodiments or examples presented herein. System 100 can be employed in many different embodiments or examples not specifically depicted or described herein.

As an example, system 100 can include: (a) server 101 and (b) one or more client computers, for example, 120 and 121. In some examples, server 101 can be configured to communicate with one or more client computers (e.g., 120 and 121) through a network. In some examples, the network can be a distributed information exchange networks, such as public and private computer networks (e.g., the Internet, intranets, WAN (wide area network), LAN (local area network), etc.), communications networks (e.g., wired or wireless networks), broadcast networks, and a homogeneous or heterogeneous combination of such networks.

“Server,” as used herein, can refer to a single server or a cluster or collection of servers. Typically, a cluster or collection of servers can be used when the demands by client computers (e.g., 120 and 121) are beyond the reasonable capability of a single server. In many embodiments, the servers in the cluster or collection of servers are interchangeable from the perspective of client computers 120 and 121.

In some examples, server 101 can include: (a) a storage component 102; (b) a header module 103; (c) an identifier module 104; (c) a content provider module 105; (e) a communications module 106; and (f) an operating system 108.

In some examples, a single server can include all of these modules. In other examples, a first server can include a first portion of storage component 102, header module 103, identifier module 104, content provider module 105, and communications module 106. One or more second servers can include a second portion of these modules. In these examples, server 101 can comprise the combination of the first server and the second server.

In some examples, storage component 102 can include a database 107. Database 107 can be a structured collection of records or data, for instance, that is stored in storage component 102. For example, database 107 can be XML (Extensible Markup Language) database, MySQL, or an Oracle® database. In the same or different embodiments, database 107 could consist of a searchable group of individual data files stored in storage component 102.

In some examples, header module 103 can be configured to generate, format and/or create headers. In some embodiments, header module 103 can generate HTTP headers. For example, header module 103 can receive identifying information from identifier module 104 and other information needed to construct the headers from storage component 102, content provider module 105, and/or communications module 106.

Identifier module 104 can be configured to assign or associate identifying information with client computers 120 and 121, for example. The identifying information can be a number, characters, or a combination of characters and numbers, for instance. For example, identifier module 104 can be configured to randomly generate identifying information. In other examples, identifier module 104 assigns identifier information from an ordered list of identifying information (e.g., the next number in a list of positive integers). In still further examples, identifier module 104 assigns identifying information at least partially based on information about the client computer. For example, identifier module 104 could assign identifying information that includes the IP (Internet Protocol) address of the client computer or the date stamp of when the first request was processed, in addition to other information. The identifier information assigned to or associated with the client computer can be used by server 101 to identify that client computer. That is, client computer 120 is assigned unique identifying information. Accordingly, when a server receives communications, including the identifying information, server 101 knows which client computer sent the communication even if other information has changed (e.g., the client computer's IP address).

Content provider module 105 can be configured to provide information and one or more files to header module 103 and/or communications module 106. In some examples, the one or more files can be stored in storage component 102. The one or more files provided to header module 103 and/or communications module 106 can include files requested by client computers 120 and 121. For example, the client computer can request a web page and content provider module 105 can provide the one or more files (e.g., image files, sound files, video files, text files, HTML files, executable scripts) that comprise the web page. Content provider module 105 can be configured to provide as part of the one or more files, files based on the identifying information and/or data associated with the identifying information. For example, content provider module 105 can provide one or more specific advertisements to be included on the web page requested by client computers 120 and/or 121. In some embodiments, content provider module 105 can use identifying information and/or the data associated with the identifying information to select at least a portion of the files provided to client computers 120 and/or 121.

Communications module 106 can be configured to aggregate the information from storage component 102, header module 103, identifier module 104, and content provider module 105. Communications module 106 can also be configured to provide the one or more files and any other information to client computers 120 and/or 121 through the network. In the same or different embodiments, communications module 106 can receive communications from client computers 120 and/or 121.

In various embodiments, operating system 108 is a software program that manages the hardware and software resources of a computer and/or a computer network. Operating system 108 performs basic tasks such as, for example, controlling and allocating memory, prioritizing the processing of instructions, controlling input and output devices, facilitating networking, and managing files. Examples of common operating systems include Microsoft® Windows, Mac® OS, UNIX® OS, and Linux® OS.

In various examples, client computer 120 can include (a) storage component 122; (b) an operating system 123; (b) a user communications interface 124 configured to communicate with the user of client computer 120; and (c) a communications module 126. In one example, user communications interface 124 includes an Internet browser 125. Storage component 122 can include browser cache 127.

As mentioned above, communication between server 101 and client computers 120 and 121 is through a network. In some examples, the network is the Internet using the HTTP Specification specified by the W3C foundation. As previously discussed, the HTTP Specification is exhaustive and specifically defined, and are the basis for how the software used to access the Internet from client computers 120 and 121 (e.g., using a web browser) communicates with server 101 via the HTTP protocol. In some examples, client computer 121 can be identical or similar to client computer 120.

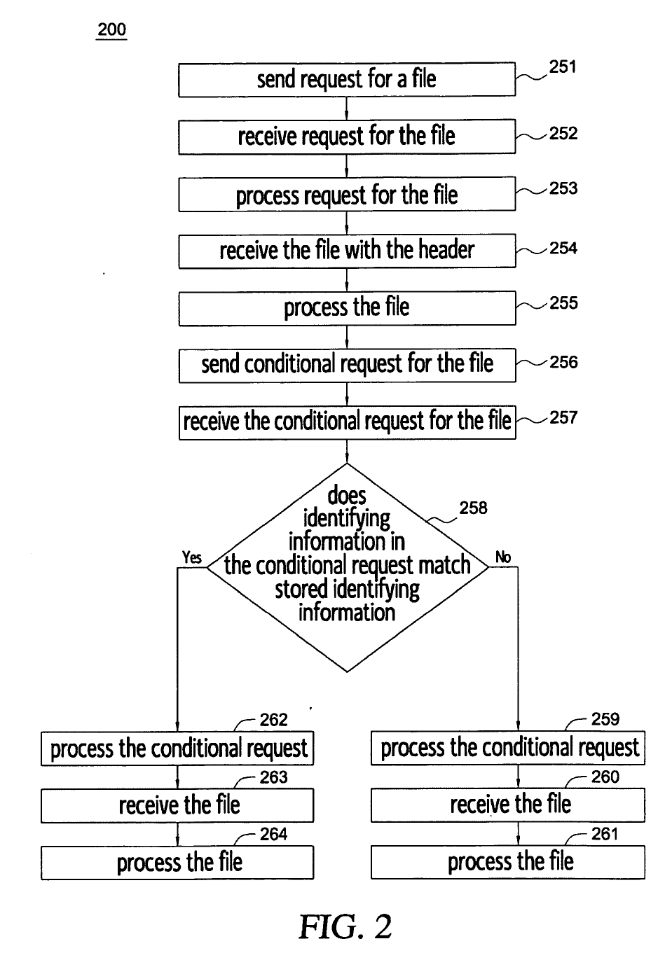

FIG. 2 is a flow chart illustrating a method 200 of displaying at least one file from a server using a client computer, according to the first embodiment. In some examples, method 200 is a method of tracking usage of a client computer. Method 200 and system 100 are merely exemplary, and not limited to the specific embodiments or examples presented herein. Accordingly, various embodiments and system 100 can be employed in many other sequences, embodiments, or examples not specifically depicted or described herein.

Referring to FIG. 2, method 200 includes a first activity 251 of sending a request for a file in some examples, the file requested can be a web page (e.g., an HTML file). In other examples, the file request can be an image file, a video file, an audio file, an executable file, a text file, or the like.

Referring again to FIG. 1, client computer 120 could send a request for a file to server 101 through the network. In some examples, a user can request the file through Internet browser 125 and communications module 126 can send the request for the file to server 101. In various embodiments, the request from client computer 120 can be a GET or POST request in accordance with the HTTP Specification.

Referring again to FIG. 2, method 200 continues an activity 252 of receiving the request for the file. Referring again to FIG. 1, in some examples, communications module 106 of server 101 receives the request from communications module 126 of client computer 120 through the network. As part of receiving the request, communications module 106 can decode the request and request the appropriate data from storage component 102, header module 103, identifier module 104, and/or content provider module 105. For example, communications module 106 can request the file from content provider module 105, and request header module 103 to provide a header for the responsive communication. In other examples, other modules can request the appropriate data from other modules of server 101.

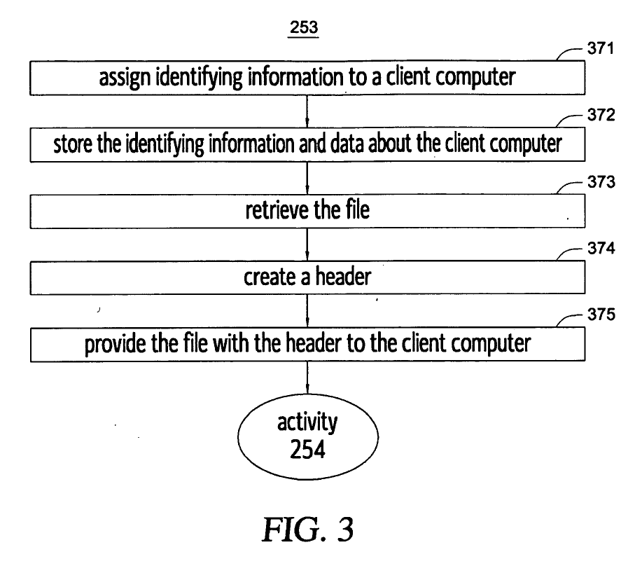

The next activity in method 200 of FIG. 2 is an activity 253 of processing the request for the file. In some examples, the processing of the request for the file can be performed by server 101 (FIG. 1). FIG. 3 is a flow chart illustrating an example of activity 253 of processing the request for the file, according to the first embodiment.

The first process in activity 253 of FIG. 3 is a process 371 of assigning identifying information to the client computer. In some examples, header module 103 (FIG. 1) requests that identifier module 104 (FIG. 1) provide identifying information for the client computer for inclusion in the header. Identifier module 104 (FIG. 1) generates the identifying information using a predetermined method (e.g., generating a random number or using the next number in a list of positive integers). Identifier module 104 (FIG. 1) can communicate the identifying information to header module 103 (FIG. 1). The identifier information assigned to or associated with the client computer can be used by server 101 to identify that client computer. That is, client computer 120 is assigned unique identifying information. Accordingly, when a server receives communications, including the identifying information, server 101 knows which client computer sent the communication even if other information has changed (e.g., the client computer's IP address).

Activity 253 of FIG. 3 continues with a process 372 of storing the identifying information and data about the client computer. The identifying information can be stored in database 107 (FIG. 1) in storage component 102 (FIG. 1). In some examples, in addition to the identifying information, the IP (Internet Protocol) address of client computer 120 (FIG. 1), the file requested, the date and time of the request, and/or other data about client computer 120 (FIG. 1) can be stored in database 107 (FIG. 1).

Furthermore, activity 253 of FIG. 3 includes a process 373 of retrieving the file. In some examples, content provider module 105 (FIG. 1) can retrieve the file from storage component 102 (FIG. 1).

Next, activity 253 of FIG. 3 includes a process 374 of creating a header for the file. Referring again to FIG. 1, in some examples, header module 103 creates the header using information received from identifier module 104, storage component 102, and content provider module 105.

In some embodiments, the header is an HTTP header. In these embodiments, the header can include an Etag header as part of the HTTP header. The Etag header includes the identifying information. For example, identifier module 104 (FIG. 1) can assign client computer 120 the identifying information of “12345.” In this example, header module can assign the Etag header field the value of “12345.” Including the unique identifying information as part of the Etag header allows server 101 to place tracking information on the client computer without having to use a cookie.

Referring again to FIG. 3, activity 253 of FIG. 3 continues with a process 375 of providing the file with the header to client computer. Referring back to FIG. 1, in some examples, communications module 106 provides the file to client computer 120 through the network. In various embodiments, communications module 106 receives the header with the identifying information from header module 103 and the file from content provider module 105. In some examples, the header provided to client computer is a HTTP header with the identifying information in the Etag header. After process 375 (FIG. 3) is complete, activity 253 (FIG. 3) is complete.

Referring aging to FIG. 2, the next activity in method 200 is an activity 254 of receiving the file with the header. Client computer 120 (FIG. 1) can receive the file with the header from server 101 (FIG. 1) through the network. In some embodiments, the header received can be an HTTP header with the identifying information in the Etag header. Communications module 126 (FIG. 1) can receive the file with the header in various examples.

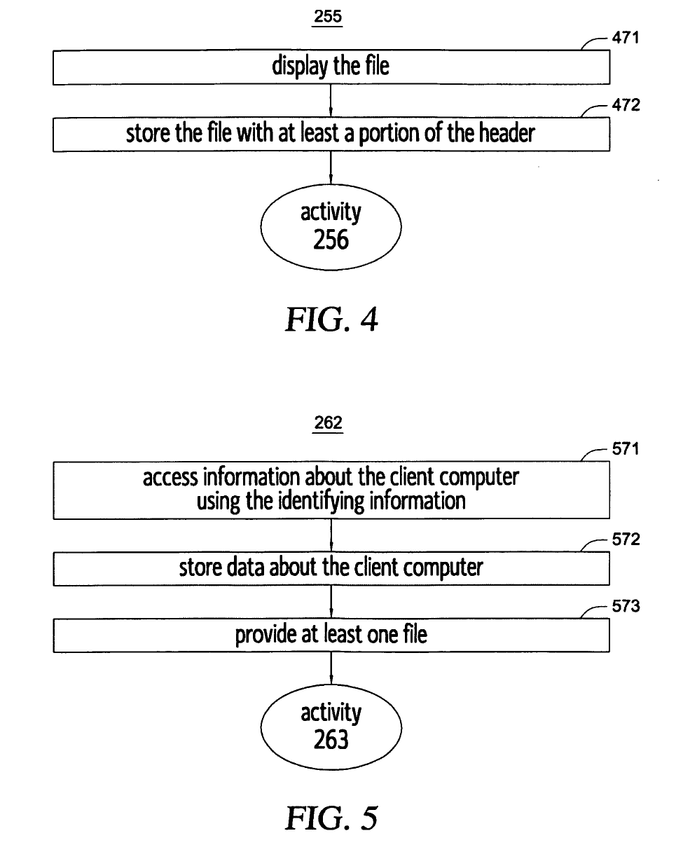

Method 200 of FIG. 2 continues with an activity 255 of processing the file. In some examples, the processing of the request for the file can be performed by client computer 120 (FIG. 1). FIG. 4 is a flow chart illustrating an example of activity 255 of processing the request for the first file, according to the first embodiment.

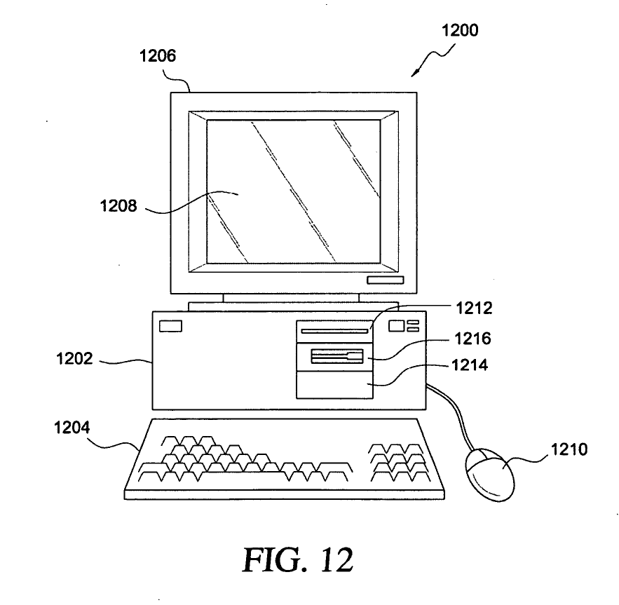

The first process in activity 255 of FIG. 4 is a process 471 of displaying the file. In some examples, client computer 120 (FIG. 1) displays the file using user using Internet browser 125 (FIG. 1) on monitor 1206 (FIG. 12).

Next, activity 255 of FIG. 4 includes a process 472 of storing the file with at least a portion of the header. Referring to FIG. 1, client computer 120 can stored the file and the portion of the header in storage component 122. In some embodiments, the file with the portion of the header in browser cache 127.

In many embodiments, the portion of the header stored with the file can include the portion of the header containing the identifying information. When the header is an HTTP header, the portion of the header stored with the file can include the Etag header, which contains the identifying information.

Placing the identifying information in a portion of the header that is stored with the file overcome one of the biggest problems with cookies. Internet browsers, following the HTTP Specification, store cookies in a separate file in a separate location than the file that they were downloaded with. Thus, a user can easily find and delete the cookie and hamper the server's ability to track client computer 120. Also, many Internet browsers give users the option to block cookies. Placing the identifying information in the Etag field allows server 101 to store identifying information in the memory of client computer 120 even when the user has instructed Internet browser 125 to block cookies.

In the same or different examples, process 472 can occur before or simultaneous with process 471. After process 472 is complete, activity 255 of FIG. 4 is complete.

Referring back to FIG. 2, the next activity in method 200 is an activity 256 of sending a conditional request for the file. After the file is received in activity 254, client computer 120 (FIG. 1) can send a second request for the file to server 101 (FIG. 1). This second request for the file can occur immediately after the first request or days, months, or even years later.

In some embodiments, the second request for the file is a conditional request for the file. As previously discussed, some communications protocols (e.g., HTTP Specification) can use a conditional request for the second or subsequent request for a file from a server. That is, client computer 120 (FIG. 1) can send a conditional request for the file to server 101 (FIG. 1) because the file was already requested and received in activities 252 and 254, respectively. The conditional request can include the identifying information.

When client computer 120 (FIG. 1) and server 101 (FIG. 1) are communicating using the HTTP protocol, client computer 120 (FIG. 1) can send an “if-none-match” HTTP request for the file. As part of the “if-none-match” HTTP request, client computer 120 (FIG. 1) can send the Etag value for the file stored in storage component 122 (FIG. 1). The Etag value associated with the file is the identifying information for client computer 120 (FIG. 1) received as part of activity 254. In the same or different embodiment, communications module 126 (FIG. 1) can create and send the conditional request with information received from storage component 122 (FIG. 1) and user communications interface 124 (FIG. 1).

Method 200 continues an activity 257 of receiving the conditional request for the file. Referring again to FIG. 1, in some examples, communications module 106 of server 101 receives the conditional request from client computer 120 through the network. As part of receiving the conditional request, communications module 106 can decode the conditional request and request the appropriate data from storage component 102, header module 103, identifier module 104, and/or content provider module 105. In other examples, other modules can request the appropriate data from other modules of in server 101.

Next, method 200 includes an activity 258 of determining whether the identifying information in the conditional request matches stored identifying information. The stored identifying information can be stored in storage component 102 (FIG. 1). In some examples, communications module 106 (FIG. 1) can check the identifying information against the identifying information stored in database 107 (FIG. 1).

If the identifying information in the conditional request does not match any identifying information stored in storage component 102 (FIG. 1), the next activity in method 200 is an activity 259 of processing the conditional request. In many examples, activity 258 is identical or substantially similar to activity 253 of FIG. 3. When the identifying information does not match, the conditional request is treated as a non-conditional request for the file:

After processing the conditional request in activity 259, the next activities in method 200 are activities 260 of receiving the file and activity 261 of processing the file. In many examples, activity 260 and 261 can be identical or substantially similar to activities 254 and 255, respectively.

If the identifying information in the conditional request matches identifying information stored in storage component 102 (FIG. 1), method 200 of FIG. 2 continues with an activity 262 of processing the conditional request. In some examples, the processing of the request for the file can be performed by server 101 (FIG. 1). FIG. 5 is a flow chart illustrating an example of activity 262 of processing the conditional request for the first file, according to the first embodiment.

The first process in activity 262 of FIG. 5 is a process 571 of accessing data about the client computer using the identifying information. In some examples, communications module 106 (FIG. 1) can access information about client computer 120 (FIG. 1). The data accessed about client computer 120 (FIG. 1) can be used in determining what information to provide client computer 120 (FIG. 1) in response to the conditional request. For example, if client computer 120 (FIG. 1) has requested a web page, the data stored about client computer 120 (FIG. 1) can be used to determine what advertisements to include in the web page. In other examples, the data stored about client computer 120 (FIG. 1) can be used to customize and/or personalize the web page provided to client computer 120 (FIG. 1).

The next process in activity 262 of FIG. 5 is a process 572 of storing data about the client computer. In some examples, communications module 106 (FIG. 1) can store information gather from the conditional request. In some examples, activity 262 can be identical or substantially similar to process 372 of FIG. 3. In other embodiments, process 572 can occur before or simultaneous with process 571.

Subsequently, activity 262 of FIG. 5 can include a process 573 of providing at least one file. Referring to FIG. 1, in some examples, server 101 can provide at least one file to client computer 120 though the network in response to the conditional request. In some examples, process 573 can be considered instructing the client computer to display at least one second file after receiving the first conditional request if the first identifying information is the same as the stored identifying information. In the same or different examples, process 573 can be considered instructing the client computer to display a first advertisement after receiving the first conditional request if the first identifying information is the same as the stored identifying information.

In some embodiments, content provider module 105 can determine which file to provide to client computer 120. In the same or different embodiments, after content provider module 105 determines the files to provide, communications module 106 can provide the files to client computer 120 through the network.

In some examples, the at least one file provided is the same file as the client computer conditionally requested. In other examples, the at least one file provided to client computer 120 (FIG. 1) is a modified version of the file requested. For example, if the file request was an HTML file, a modified version of the HTML file could be provided to client computer 120. In various embodiments, the HTML file can be modified by personalizing or customizing the HTML page. In the same or different embodiments, the HTML file can be modified by changing an advertisement in the HTML file. In some examples, the advertisement can be selected from at least two potential advertisements at least partially on the identifying information of the client computer and/or other information know about the client computer.

In yet another example, a second file, different than the first file, can be provided to client computer 120 in response to the conditional request. For example, if the conditional request was for a first image file. The first image file could be a first advertisement. However, content provider module 105 could determine that server 101 should provide a second image file (e.g., a second advertisement) to client computer 120 instead of the first image file. In this example, the second file can be provided to client computer 120. After providing the at least one file, activity 262 is complete. The advertisement provided can be selected from at least two potential advertisements at least partially on the identifying information of the client computer and/or other information known about the client computer. In some examples, the file provided in process 573 can include a header with the identifying information.

In some embodiments, server 101 (FIG. 1) provides a file is to the client computer 120 (FIG. 1) when the file has not already been provided to client computer 120. That is, the file provided is a modified version of the file requested or a different file. In these embodiments, if the file has already been provided to client computer 120, server 101 (FIG. 1) can send a “304 not-modified” status message, consistent with the HTTP Specification, to client computer 120 (FIG. 1).

Referring again to FIG. 2, the next activities in method 200 are activities 263 of receiving the file and activity 264 of processing the file. In many examples, activity 263 and 264 can be identical or substantially similar to activities 254 and 255, respectively. In some examples, activity 263 can be considered receiving first instructions from the server.

After activity 264 (or activity 261) is complete, method 200 is complete unless another request or conditional request for the file is initiated by client computer 120 (FIG. 1). If another request or conditional request is initiated, portions or all of method 200 can be repeated.

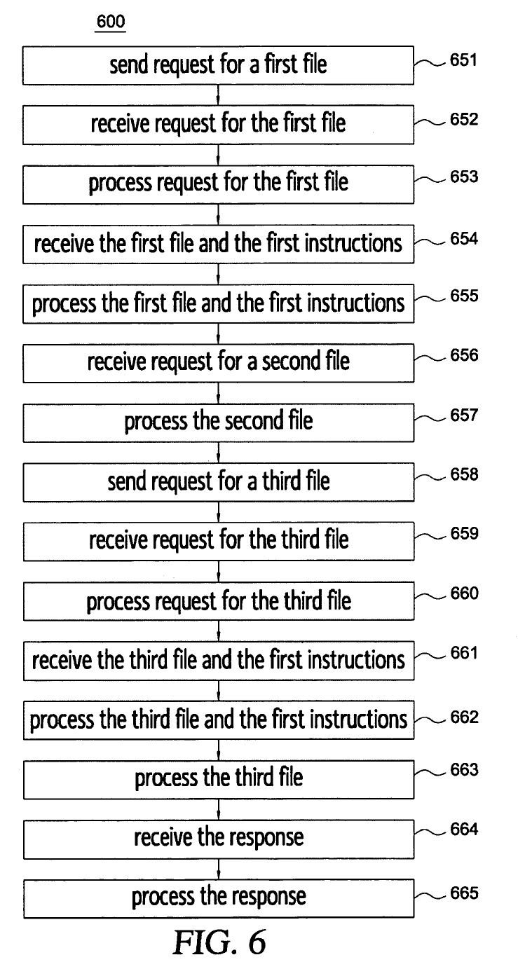

Turning to another embodiment, FIG. 6 is a flow chart illustrating a method 600 of displaying at least one file from a server using a client computer, according to a second embodiment. In some examples, method 600 can be considered a method of tracking usage of a client computer. Method 600 is merely exemplary, and is not limited to the specific embodiments or examples presented herein. Accordingly, method 600 can be employed in many other sequences, embodiments, or examples not specifically depicted or described herein.

Referring again to FIG. 1, as a simple and non-limiting example of the second embodiment, a client computer 120 can make an initial non-conditional request to server 101 for a first file. Server 101 returns the first file along with instruction (e.g., an executable script) instructing the client computer 120 to download a second file. The client computer 120 requests the second file, which is provided to the client computer 120 with an Etag header containing identifying information. Also, after receiving the request for the second file, server 101 creates an entry in database 107 that relates identifying information to client computer 120, and stores any behavior or usage information for client computer 120 in relation to that identifying information.

When client computer 120 makes subsequent requests for the first file or a third file (different than the first file or second file) to server 101, server 101 returns the first or third file and instructed client computer 120 to attempt to access the second file. If the second file is already stored in the memory of client computer 120 and tagged was the identifying information as outlined above, client computer 120 sends a conditional request with the identifying information to server 101.

At this point, server 101 has the identifying information for client computer 120. In some examples, server 101 then provides the second file to the client computer with a header containing no Etag header. Because no Etag header is returned, the cached second file on the client computer 120 is not updated and retains the same Etag value.

Referring to FIG. 6, method 600 includes a first activity 651 of sending a request for a first file. In some examples, activity 651 can be identical or substantially similar to activity 251 of FIG. 2.

The next activity in method 600 is an activity 652 of receiving the request for the first file. In some examples, activity 652 can be identical or substantially similar to activity 252 of FIG. 2.

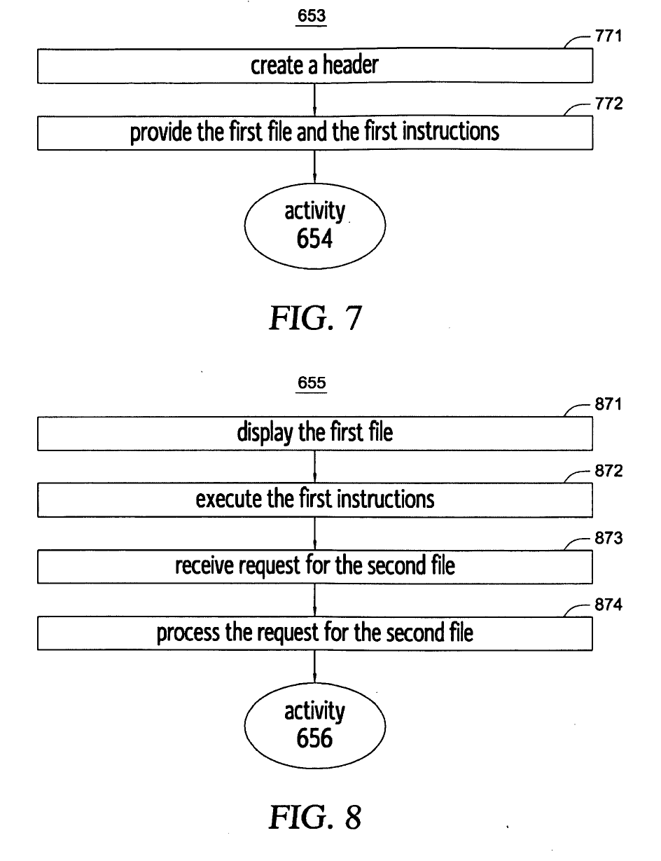

Method 600 of FIG. 6 continues with an activity 653 of processing the request for the first file. FIG. 7 is a flow chart illustrating an example of activity 653 of processing the request for the first file, according to the second embodiment.

The first process of activity 653 of FIG. 7 is a process 771 of creating a header. Referring again to FIG. 1, in some examples, header module 103 creates the header using information received from storage component 102 and content provider module 105. In many embodiments, the header does not contain any identifying information. In some embodiments, the header is an HTTP header, and the header does not include an Etag header as part of the HTTP header. In other examples, the HTTP header includes an Etag header with the first file, and the Etag header is conventional Etag header information.

Referring again to FIG. 7, activity 653 further includes a process 772 of providing the first file and first instructions. In some examples, server 101 (FIG. 1) provides the first file and first instructions to client computer 120 (FIG. 1) through the network. In some examples, activity 653 can be considered instructing the client computer to request a second file.

In some examples, the first instructions can be an executable script. When executed by client computer 120, the first instructions can initiate a request to server 101 (FIG. 1) to provide a second file with identifying information. The first instructions can be implemented using a suitable client side scripting language (e.g., ASP (Activity Server Page), PHP (PHP Hypertext Preprocessing)). After providing the first file and the first instructions, activity 653 of FIG. 6 is complete.

Referring again to FIG. 6, the next activity in method 600 is an activity 654 of receiving the first file and the first instructions. Client computer 120 (FIG. 1) can receive the first file and the first instructions from server 101 (FIG. 1) through the network. Communications module 126 (FIG. 1) can receive the first file and first instructions in various examples.

Method 600 of FIG. 6 continues with an activity 655 of processing the first file and the first instructions. In some examples, the processing of the request for a first file can be performed by client computer 120 (FIG. 1). FIG. 8 is a flow chart illustrating an example of activity 655 of processing the request for the first file, according to the second embodiment.

The first process in activity 655 of FIG. 8 is a process 871 of displaying the first file. In some examples, client computer 120 (FIG. 1) displays the first file using user in Internet browser 125 (FIG. 1) on monitor 1206 (FIG. 12). In some examples, process 871 can be identical or similar to process 471 of FIG. 4. In other examples, process 871 can be performed after or concurrent with process 872, 873, or 874 of FIG. 8

The next process in activity 655 of FIG. 8 is a process 872 of executing the first instructions. Executing the first instructions causes a request for a second file to be sent to server 101 (FIG. 1) without any action of the user of client computer 120 (FIG. 1). The purpose of the request to the second file is that server 101 provides a second file with identifying information in the header to client computer 120. In some examples, communications module 126 (FIG. 1) requests the second file based on the first instructions.

The next process in activity 655 of FIG. 8 is a process 873 of receiving the request for the second file. The receiving of the request for the second file can be similar or identical to activity 252 of FIG. 2 or activity 652 of FIG. 6. The request for the second file can be received by communications module 106 (FIG. 1).

After receiving the request for the second file, the next process in activity 655 is a process 874 of processing the request for the second file. In some examples, the processing of the request for the second file can be performed by server 101 (FIG. 1). Process 874 can be similar or identical to activity 253 (FIG. 2). In some examples, as part of process 874, the second file with a header including identifying information can be provided to client computer 120 (FIG. 1) from server 101 (FIG. 1). In various embodiments, the second file contains little or no data. The function of the second file is to deliver a header including identifying information to client computer 120 (FIG. 1). After processing the request for the second file, activity 655 is complete.

Referring again to FIG. 6, the next activity in method 600 is an activity 656 of receiving the second file. Client computer 120 (FIG. 1) can receive the second file from server 101 (FIG. 1) through the network. Communications module 126 (FIG. 1) can receive the second file in various examples. The receiving of the second file can be similar or identical to activity 254 of FIG. 2.

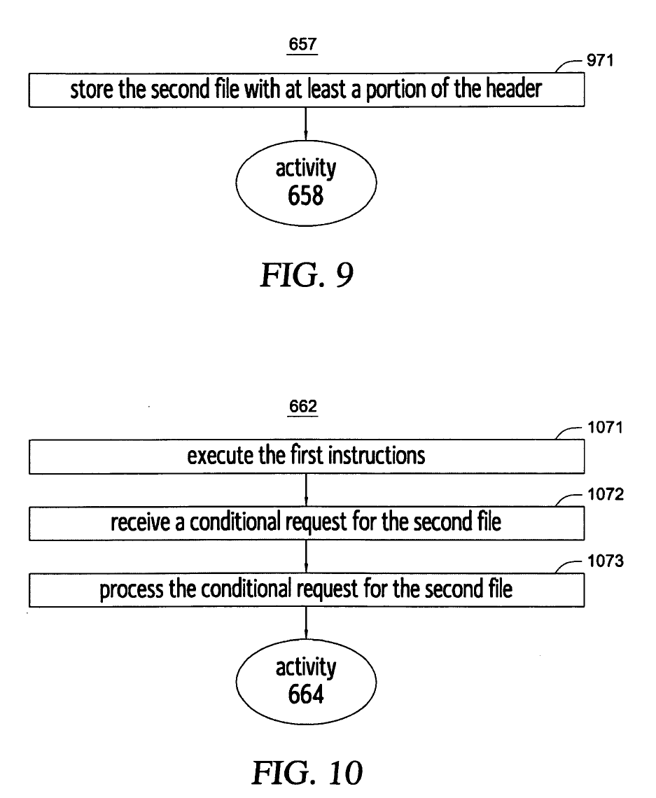

Method 600 of FIG. 6 continues with an activity 657 of processing the second file. The processing of the second can be performed by client computer 120 (FIG. 1). FIG. 9 is a flow chart illustrating an example of activity 657 of processing the second file, according to the second embodiment.

Activity 657 of FIG. 9 includes a process 971 of storing the second file with at least a portion of the header. Referring to FIG. 1, client computer 120 can store the second file and the portion of the header in storage component 122. In some embodiments, the second file with the portion of the header is stored in browser cache 127. The portion of the header stored can include the identifying information. When the header is an HTTP header, the portion of the header stored with the file can include the Etag header, which contains the identifying information. In many examples, process 971 can be identical or similar to process 472 of FIG. 4.

Placing the identifying information in a portion of the header that is stored with the file overcome one of the biggest problems with cookies. Internet browsers, following the HTTP Specification, store cookies in a separate file in a separate location than the file that they were downloaded with. Thus, a user can easily find and delete the cookie and hamper the server's ability to track client computer 120. Also, many Internet browsers give users the option to block cookies. Placing the identifying information in the Etag field allows server 101 to store identifying information in the memory of client computer 120 even when the user has instructed Internet browser 125 to block cookies.

After storing the second file with at least a portion of the header, activity 657 of FIG. 9 is complete.

Referring back to FIG. 6, method 600 continues with an activity 658 of sending a request for a third file. In many embodiments, requesting of the third file can be similar or identical to activity 651. In some examples, the third file can be different than the first file. In these examples, client computer 120 sends a non-conditional request for the third file.

In other examples, the third file can be the first file. When the third file is the first file, client computer 120 makes a non-conditional request for the first/third file because an Etag header was not included with the first file. Under the HTTP Specification, conditional requests for a file are made when the file is stored with an Etag header. In other examples, if the first file has an Etag header, client computer 120 makes a conditional request.

The next activity in method 600 is an activity 659 of receiving the request for the third file. In some examples, activity 659 can be identical or substantially similar to activity 252 of FIG. 2 or activity 652 of FIG. 6.

Method 600 of FIG. 6 continues with an activity 660 of processing the request for the third file. In some examples, activity 660 can be identical or similar to activity 653 of FIG. 6. As part of activity 660, server 101 provides the third file and the first instructions to client computer 120.

The next activity in method 600 is an activity 661 of receiving the third file and the first instructions. Client computer 120 (FIG. 1) can receive the third file and the first instructions from server 101 through the network. Communications module 126 (FIG. 1) can receive the third file and first instructions in various examples.

Method 600 of FIG. 6 continues with an activity 662 of processing the third file and the first instructions. In some examples, the processing of the third file can be performed by client computer 120 (FIG. 1). FIG. 10 is a flow chart illustrating an example of activity 662 of processing the third file and the first instructions, according to the second embodiment.

The first process in activity 662 of FIG. 10 is a process 1071 of executing the first instructions. Executing the first instructions causes a request for the second file to be sent to server 101 (FIG. 1) without any action of the user of client computer 120.

When the first instruction were executed in process 871 of FIG. 8, client computer 120 (FIG. 1) sent a non-conditional request for the second file. However, the second file with an Etag header was already received by client computer 120 (FIG. 1) in activity 656 of FIG. 6 and the second file with at least a portion of the header was stored in storage component 122 (FIG. 1) by client computer 120 (FIG. 1) in process 972 of FIG. 9. Accordingly, a conditional request for the second file is sent in process 1071. The conditional request includes the identifying information. In many examples, client computer 120 (FIG. 1) sends the conditional request to server 101 (FIG. 1). In various embodiments, the conditional request can be an “if-none-match” header containing the value of the Etag of the second file stored in storage component 122 (FIG. 1).

The next process in activity 662 of FIG. 10 is a process 1072 of receiving the conditional request for the second file. In some examples, process 1072 can be identical or similar to activity 257 of FIG. 2. Referring again to FIG. 1, in some examples, communications module 106 of server 101 receives the conditional request from client computer 120 through the network. As part of receiving the conditional request, communications module 106 can decode the conditional request and request the appropriate data from storage component 102, header module 103, identifier module 104, and/or content provider module 105. In other examples, other modules can request the appropriate data from other modules of server 101.

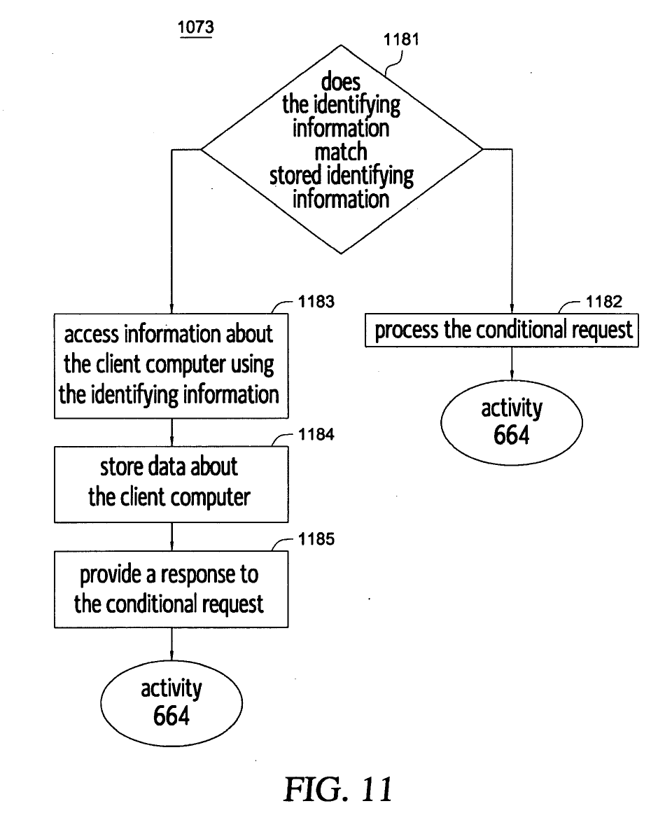

Referring again to FIG. 10, activity 662 of FIG. 10 continues with a process 1073 of processing the conditional request for the second file. FIG. 11 is a flow chart illustrating an example of process 1073 of processing the conditional request for the second file, according to the second embodiment.

The first procedure in process 1073 of FIG. 11 is a procedure 1181 of determining whether the identifying information in the conditional request matches any stored identifying information. In some examples, communications module 106 (FIG. 1) can check the identifying information against the identifying information stored in database 107 (FIG. 1).

If the identifying information in the conditional request does not match any identifying information stored in storage component 102 (FIG. 1), the next procedure in process 1073 is a procedure 1182 of processing the conditional request. Because no corresponding identifying information is stored in storage component 102 (FIG. 1), the conditional request is treated as a non-conditional request. In many examples, procedure 1182 is identical or substantially similar to process 873 of FIG. 8.

If the identifying information in the conditional request matches identifying information stored in storage component 102 (FIG. 1), process 1073 of FIG. 11 continues with a procedure 1183 of accessing data about the client computer using the identifying information. In some examples, communications module 106 (FIG. 1) can access data about client computer 120 (FIG. 1). In some examples, process 1073 can be identical or similar to process 571 of FIG. 5.

Referring again to FIG. 11, the next process in process 1073 of FIG. 11 is a procedure 1184 of storing data about the client computer. In some examples, communications module 106 (FIG. 1) can store data gathered from the conditional request. Procedure 1184 can occur before, after, or simultaneous with procedure 1183. In some examples, process 1073 can be identical or similar to process 373 of FIG. 3 and/or process 572 of FIG. 5.

Subsequently, process 1073 of FIG. 11, can include a procedure 1185 of responding to the conditional request. Server 101 (FIG. 1) can respond to client computer 120 (FIG. 1) though the network. In some examples, server 101 (FIG. 1) responds to the conditional request with a response that informs client computer 120 that the second file as not changed. For example, server 101 can respond with a status of “304 not-modified,” which tells client computer 120 (FIG. 1) to use the version of the second file stored in storage component 122 (FIG. 1).

In other embodiments, server 101 (FIG. 1) can respond to client computer 120 (FIG. 1) by providing the second file with a header containing the identifying information for client computer 120 (FIG. 1) or other information.

In some embodiments, content provider module 105 (FIG. 1) can determine the response to provide to client computer 120 (FIG. 1). In the same or different embodiments, after content provider module 105 (FIG. 1) determines the response to provide, communications module 106 (FIG. 1) can provide the files to client computer 120 (FIG. 1) through the network. After procedure 1185, process 1073 and activity 663 are complete.

Referring again to FIG. 6, the next activities in method 600 are activity 664 of receiving the file and activity 665 of processing the file. In many examples, activity 664 and 665 can be identical or similar to activities 254 and 255, respectively of FIG. 2 or activities 659 and 660, respectively, of FIG. 6.

After activity 660 is complete, method 600 is complete unless another file is requested by client computer 120 (FIG. 1).

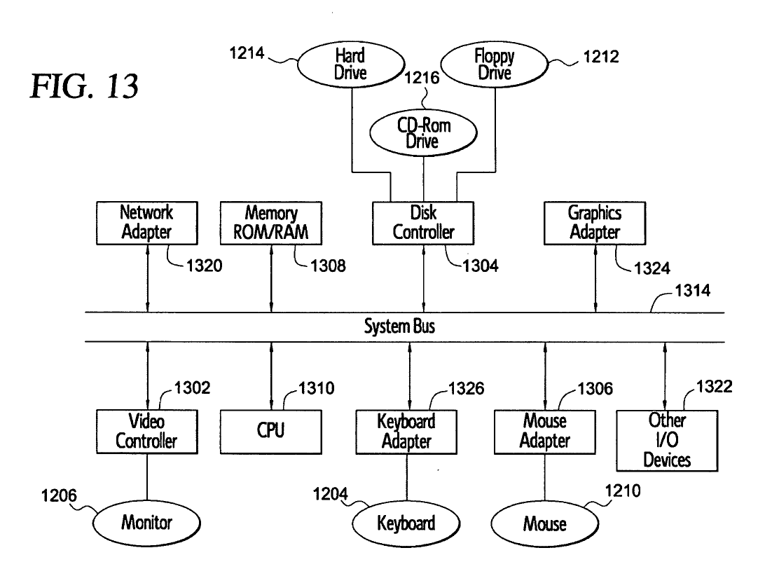

FIG. 12 illustrates a computer 1200 that is suitable for implementing an embodiment of server 101 (FIG. 1). Computer 1200 can also be an example a device suitable for use as client computers 120 and/or 121 (FIG. 1). Computer 1200 includes a chassis 1202 containing one or more circuit boards (not shown), a floppy drive 1212, a Compact Disc Read-Only Memory (CD-ROM) drive 1216, and a hard drive 1214. A representative block diagram of the elements included on the circuit boards inside chassis 1202 is shown in FIG. 13. A central processing unit (CPU) 1310 in FIG. 13 is coupled to a system bus 1314 in FIG. 13. In various embodiments, the architecture of CPU 1310 can be compliant with any of a variety of commercially distributed architecture families including the RS/6000 family, the Motorola 68000 family, or the Intel x86 family.

System bus 1314 also is coupled to memory 1308 that includes both read-only memory (ROM) and random access memory (RAM). Non-volatile portions of memory 1308 or the ROM can be encoded with a boot code sequence suitable for restoring computer 1200 (FIG. 12) to a functional state after a system reset. In addition, memory 1308 can include microcode such as a Basic Input-Output System (BIOS).

In the depicted embodiment of FIG. 13, various I/O devices such as a disk controller 1304, a graphics adapter 1324, a video controller 1302, a keyboard adapter 1326, a mouse adapter 1306, a network adapter 1320, and other I/O devices 1322 can be coupled to system bus 1314. Keyboard adapter 1326 and mouse adapter 1306 are coupled to a keyboard 1204 (FIGS. 12 and 13) and a mouse 1210 (FIGS. 12 and 13), respectively, of computer 1200 (FIG. 12). While graphics adapter 1324 and video controller 1302 are indicated as distinct units in FIG. 13, video controller 1302 can be integrated into graphics adapter 1324, or vice versa in other embodiments. Video controller 1302 is suitable for refreshing a monitor 1206 (FIGS. 12 and 13) to display images on a screen 1208 (FIG. 12) of computer 1200 (FIG. 12). Disk controller 1304 can control hard drive 1214 (FIGS. 12 and 13), floppy drive 1212 (FIGS. 12 and 13), and CD-ROM drive 1216 (FIGS. 12 and 13). In other embodiments, distinct units can be used to control each of these devices separately.

Although many other components of computer 1200 (FIG. 12) are not shown, such components and their interconnection are well known to those of ordinary skill in the art. Accordingly, further details concerning the construction and composition of computer 1200 and the circuit boards inside chassis 1202 (FIG. 12) need not be discussed herein. Also, in some examples, computer 1200 (FIG. 12) does not include all of the elements shown in FIGS. 11 and 12. For example, computer 1200 (FIG. 12) might not include a mouse 1210 (FIGS. 12 and 13) and/or keyboard 1204 (FIGS. 12 and 13).

When computer 1200 in FIG. 12 is running, program instructions stored on a floppy disk in floppy drive 1212, on a CD-ROM in CD-ROM drive 1216, on hard drive 1214, or in memory 1308 (FIG. 13) are executed by CPU 1310 (FIG. 13). A portion of the program instructions, stored on these devices, can be suitable for carrying out the method of displaying information from a server using a client computer or track usage of a client computer as described previously with respect to FIGS. 1-11.

Although the invention has been described with reference to specific embodiments, it will be understood by those skilled in the art that various changes may be made without departing from the spirit or scope of the invention. For example, it will be readily apparent, a server can also use cookies to track a client computer at the same time the server is using one or more of the methods of tracking a client computer described herein. Additional examples of such changes have been given in the foregoing description. Accordingly, the disclosure of embodiments is intended to be illustrative of the scope of the invention and is not intended to be limiting. It is intended that the scope of the invention shall be limited only to the extent required by the appended claims. To one of ordinary skill in the art, it will be readily apparent that the method, system, and computer-readable medium discussed herein may be implemented in a variety of embodiments, and that the foregoing discussion of certain of these embodiments does not necessarily represent a complete description of all possible embodiments. Rather, the detailed description of the drawings, and the drawings themselves, disclose at least one preferred embodiment, and may disclose alternative embodiments.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A method of tracking usage of a client computer, the method comprises:
receiving from the client computer a first request for a first file;
assigning first identifying information to the client computer, wherein the first identifying information is associated with the client computer;
providing the first file with a first header to the client computer, the first header comprises the first identifying information;
receiving from the client computer a first conditional request for the first file, the first conditional request comprises second identifying information;
accessing first data about the client computer using the second identifying information after receiving the first conditional request if the first identifying information is the same as the second identifying information, and
instructing the client computer to display at least one second file after receiving the first conditional request if the first identifying information is the same as the second identifying information.

2. The method of claim 1, further comprising:
instructing the client computer to request the first file.

3. The method of claim 1, further comprising:
receiving a first request for the at least one second file before receiving the first request for the first file; and
providing first instructions in response to the first request for the at least one second file, wherein:
the first instructions instruct the client computer to request the first file.

4. The method of claim 3, further comprising:
in response to the first request for the at least one second file, providing the at least one second file.

5. The method of claim 1, further comprising:
receiving a second conditional request for the first file, wherein the second conditional request comprises third identifying information;
accessing at least the first data about the client computer using the third identifying information after receiving the second conditional request if the first identifying information is the same as the third identifying information;
instructing the client computer to display the at least one second file after receiving the second conditional request if the first identifying information is the same as the third identifying information.

6. The method of claim 1, further comprising:
storing the first identifying information and the first data about the client computer after receiving the first request for the first file.

7. The method of claim 1, further comprising:
storing second data about the client computer after receiving the first conditional request if the first identifying information is the same as the second identifying information.

8. The method of claim 1, wherein:
instructing the client computer to display the at least one second file comprises:
providing the at least one second file to the client computer after receiving the first conditional request if the first identifying information is the same as the second identifying information.

9. The method of claim 1, wherein:
instructing the client computer to display the at least one second file comprises:
instructing the client computer to display a first advertisement after receiving the first conditional request if the first identifying information is the same as the second identifying information;
the at least one second file comprises the first advertisement.

10. The method of claim 9, further comprising:
selecting the first advertisement based at least partially on the second identifying information,
wherein:
the first advertisement is selected from at least two potential advertisements.

11. The method of claim 1, wherein:
providing the first file with the first header to the client computer comprises:
providing the first file with an Etag header to the client computer;
the Etag header comprises the first identifying information; and
the first header is the Etag header.

12. The method of claim 1, wherein:
receiving a first conditional request for the first file from the client computer comprises:
receiving an if-none-match request for the first file from the client computer;
the if-none-match request comprises the second identifying information, and
the first conditional request is the if-none-match request.

13. The method of claim 1, further comprising:
sending the first request for the first file to the server;
receiving the first file with the first header;
storing the first file with the first identifying information in the client computer;
sending the first conditional request for the first file to the server, the first conditional request comprises the first identifying information;
receiving first instructions from the server to display the at least one second file;
displaying using the client computer the at least one second file to the user,
wherein:
the first identifying information is the same as the second identifying information.

14. A method of displaying at least one first file from a server using a client computer, the method comprising:
sending a first request for a second file to the server;
receiving the second file with a first header, the first header comprises identifying information, the identifying information is associated with the client computer;
storing the second file with the identifying information;
sending a first conditional request for the second file to the server, the first conditional request comprises the identifying information;
receiving first instructions from the server to display the at least one first file; and
displaying using the client computer the at least one first file to the user.

15. The method of claim 14, further comprising:
sending a first request for a third file to the server before sending the first request for the second file;
receiving second instructions in response to the first request for the third file; and
performing the second instructions,
wherein:
performing the second instructions comprises:
sending the first request for the second file to the server.

16. The method of claim 14, wherein:
displaying the at least one first file comprises:
displaying at least one first file on a monitor of the client computer.

17. The method of claim 14, wherein:
receiving the second file with the first header comprises:
receiving the second file with an Etag header from the server;
the Etag header comprises the first identifying information; and
the first header is the Etag header.

18. The method of claim 14, wherein:
sending the first conditional request for the second file to the server comprises:
sending an if-none-match request for the second file to the server;
the if-none-match request comprises the first identifying information; and
the first conditional request is the if-none-match request.

19. The method of claim 14, wherein:
the at least one first files comprises the second file.

20. A computer-readable storage medium that stores instructions executable by at least one processor on a server, the computer-readable storage medium comprising:
instructions for processing a first request for a first file from a client computer;
instructions for assigning and facilitating storage of first identifying information associated with the client computer;
instructions for providing the first file with a first header to the client computer, the first header comprises the first identifying information;
instructions for receiving and processing a first conditional request for the first file from the client computer, the first conditional request comprises second identifying information;
instructions for accessing first data about the client computer after receiving the first conditional request if the first identifying information is the same as the second identifying information; and
instructions for instructing the client computer to display at least one second file after receiving the first conditional request if the first identifying information is the same as the second identifying information.

21. The computer-readable storage medium of claim 20, wherein:
instructions for receiving and providing the first file comprise:
instructions for receiving and providing the first file with an Etag header to the client computer;
the Etag header comprises the first identifying information; and
the first header is the Etag header.

22. The computer-readable storage medium of claim 20, wherein:
instructions for processing the first conditional request comprise:
instructions for processing an if-none-match request;
the if-none-match request comprises the second identifying information; and
the first conditional request is the if-none-match request.

23. A computer-readable storage medium that stores instructions executable by at least one processor on a client computer, the computer-readable storage medium comprising:
instructions for sending a first request for a first file to a server;
instructions for receiving and processing the first file with a first header, the first header comprises first identifying information, the first identifying information is associated with the client computer;
instructions for facilitating storage of the first file with the first header;
instructions for sending a first conditional request for the first file to the server, the first conditional request comprises the first identifying information;
instructions for receiving and processing first instructions from the server; and
instructions for displaying at least one second file to the user based on the first instructions.

24. The computer-readable storage medium of claim 23, wherein:
instructions for receiving and processing the first file comprise:
instructions for receiving and processing the first file with an Etag header;
the Etag header comprises the first identifying information; and
the first header is the Etag header.

25. The computer-readable storage medium of claim 23, wherein:
instructions for sending the first conditional request comprise:
instructions for sending an if-none-match request for the first file to the server;
the if-none-match request comprises the first identifying information; and
the first conditional request is the if-none-match request.
